(19) United States
(12) Patent Application Publication
(10) Pub. No.: US 2025/0028549 A1
(43) Pub. Date: Jan. 23, 2025

(54) SECURITY ORCHESTRATION FOR ON-PREMISES INFRASTRUCTURE

(71) Applicant: VMWARE, INC., Palo Alto, CA (US)

(72) Inventors: SIDDHARTH BURLE, Pune (IN); AMIT MEENA, Pune (IN); SANJAY KUMAR, Jersey City, NJ (US); SAIFUDDIN RANGWALA, Pune (IN)

(21) Appl. No.: 18/376,452

(22) Filed: Oct. 4, 2023

(30) Foreign Application Priority Data
Jul. 17, 2023 (IN) 202341047933

(51) Int. Cl. G06F 9/455; G06F 9/445

(52) U.S. Cl. CPC G06F 9/45558; G06F 9/44526; G06F 2009/45591

(57) ABSTRACT

Techniques associated with security orchestration for on-premises infrastructure are disclosed. A policy definition associated with on-premises infrastructure that defines a desired state can be received. From the policy definition, a target of the on-premises infrastructure can be identified. A management service associated with the target can be determined, and a plugin for the management service can be identified. The policy definition can be communicated to the management service through the plugin, and the management service sets the state of the target to the desired state. The state of the target can be monitored. If the state differs from the desired state, a remediation workflow is initiated to set the state to the desired state specified by the policy definition.

### RELATED APPLICATIONS

Benefit is claimed under 35 U.S.C. 119(a)-(d) to Foreign application Ser. No. 202341047933 filed in India entitled “SECURITY ORCHESTRATION FOR ON-PREMISES INFRASTRUCTURE”, on Jul. 17, 2023, by VMware, Inc., which is herein incorporated in its entirety by reference for all purposes.

Software defined networking (SDN) involves a plurality of hosts in communication over a physical network infrastructure of a data center (e.g., an on-premises data center or a cloud data center). The physical network to which the plurality of physical hosts is connected may be referred to as an underlay network. Each host has one or more virtualized endpoints, such as virtual machines (VMs), containers, Docker containers, data compute nodes, isolated user space instances, namespace containers, and/or other virtual computing instances (VCIs), which are connected to, and may communicate over, logical overlay networks. For example, the VMs and/or containers running on the hosts may communicate with each other using an overlay network established by hosts using a tunneling protocol.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods.

Containerized workloads may run with a container orchestration platform that automates much of the operational effort required to run containers with workloads and services. This operational effort includes a wide range of things needed to manage a container's lifecycle, including, but not limited to, provisioning, deployment, scaling (e.g., up and down), networking, and load balancing. Kubernetes® (K8S®) software is an example open-source container orchestration platform that automates the operation of such containerized workloads. A container orchestration platform may manage one or more clusters, such as a K8S cluster, including a set of nodes that run containerized applications.

As part of an SDN, any arbitrary set of VCIs in a data center may be placed in communication across a logical Layer 2 (L2) overlay network by connecting them to a logical switch. A logical switch is an abstraction of a physical switch collectively implemented by a set of virtual switches on each node (e.g., host machine or VM) with a VCI connected to the logical switch. The virtual switch on each node operates as a managed edge switch implemented in software by a hypervisor or operating system (OS) on each node. Virtual switches provide packet forwarding and networking capabilities to VCIs running on the node. In particular, each virtual switch uses hardware-based switching techniques to connect and transmit data between VCIs on the same node or different nodes.

A pod may be deployed on a single VM or a physical machine. The single VM or physical machine running a pod may be referred to as a node running the pod. From a network standpoint, containers within a pod share the same network namespace, meaning they share the same internet protocol (IP) address or IP addresses associated with the pod.

A network plugin, such as a container networking interface (CNI) plugin, may be used to create virtual network interface(s) usable by the pods for communicating on respective logical networks of the SDN infrastructure in a data center. In particular, the network plugin may be a runtime executable that configures a network interface, referred to as a pod interface, into a container network namespace. The network plugin is further configured to assign a network address (e.g., an IP address) to each created network interface (e.g., for each pod) and may also add routes relevant to the interface. Pods can communicate with each other using their respective IP addresses. For example, packets sent from a source pod to a destination pod may include a source IP address of the source pod and a destination IP address of the destination pod so that the packets are appropriately routed over a network from the source pod to the destination pod.

Communication between pods of a node may be accomplished through use of virtual switches implemented in nodes. Each virtual switch may include one or more virtual ports (Vports) that provide logical connection points between pods. For example, a pod interface of a first pod and a pod interface of a second pod may connect to Vport(s) provided by the virtual switch(es) of their respective nodes to allow for communication between the first and second pods. In this context, “connect to” refers to the capability of conveying network traffic, such as individual network packets or packet descriptors, pointers, or identifiers, between components to effectuate a virtual data path between software components.

Security for such an infrastructure is important. However, the complexity of the infrastructure can make it difficult to manage and govern security policies.

### SUMMARY

One or more embodiments of a method for orchestrating a security policy with respect to an on-premises infrastructure are disclosed. The method can comprise receiving a policy definition associated with on-premises infrastructure that defines a desired state, identifying a target of the on-premises infrastructure from the policy definition, determining a management service associated with the target, identifying a plugin for the management service, and communicating the policy definition to the management service through the plugin, wherein the management service sets a state of the target to the desired state. The method can further comprise requesting a current state of the target from the management service through the plugin, receiving the current state, determining the current state is different from the desired state, and initiating a remediation workflow to set the target to the desired state.

Further embodiments include one or more non-transitory computer-readable storage media storing instructions that, when executed by one or more processors of a computer system, cause the computer system to perform the method set forth above, and a computer system including at least one processor and memory configured to carry out the method set forth above.

### BRIEF DESCRIPTION OF THE DRAWINGS

FIG. 1 illustrates a computing system in which embodiments described herein may be implemented.

FIG. 2 is a block diagram of an example security orchestration system for on-premises infrastructure, according to an example embodiment of the subject disclosure.

FIG. 3 is a flow chart diagram of an example method of security orchestration, according to an example embodiment of the subject disclosure.

FIG. 4 is a sequence diagram depicting an example execution flow associated with security orchestration, according to an embodiment of the subject disclosure.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

Modern on-premises management is replacing traditional on-premises management. Traditional on-premises management utilizes self-hosted infrastructure owned and managed by an organization. For example, an organization can own and operate all computing resources within its premises, including dedicated data centers, servers, networking equipment, and storage devices. Modern on-premises management seeks to blend the data security of traditional on-premises software with the operational case of using multi-tenant system-as-a-service (SaaS) software on a virtual private cloud. Modern on-premises applications are delivered to clusters controlled through Kubernetes by organizations where data already resides.

Many organizations are running business-critical workloads in virtualized environments. Further, many workloads are executed on a single physical host. If an attacker compromises a virtual host, the attacker may have access to many workloads and not just a single traditional physical server. Accordingly, security in virtualized environments is important. In addition to security concerns, organizations are often bound by compliance regulations that mandate that various security and safeguards are in place. Various tools and product features exist related to security and regulatory compliance. For example, a user can utilize tools to scan an environment for compliance with specific regulations and standards. If non-compliance is detected, other tools can be utilized to remediate an issue. However, this is an imperative way of orchestrating the compliance lifecycle that consumes considerable time and requires expertise associated with many tools rendering the process inaccessible to some or at least performed less often. Furthermore, product features (e.g., hypervisor with security features) can have great capabilities, but there is still no way of ensuring that a desired system state is maintained. Consequently, attacks against modern on-premises systems are increasing.

Aspects of the subject disclosure pertain to automating and streamlining the definition and enforcement of a desired state configuration. An administrator can define one or more guardrails, such as, but not limited to, a VMware Aria guardrail. A guardrail is a high-level concept that specifies a security or compliance objective and comprises one or more policies associated with on-premises infrastructure, including self-hosted and private cloud infrastructure. A policy comprises a set of rules that define desired behavior or configuration, including what is allowed or prohibited. Rules define specific actions, configurations, or restrictions to follow to comply with the policy. For example, a rule within a policy can indicate that a virtual switch address should not be changed, which could be at least a portion of a network configuration policy associated with guardrail specifying best practices for managing network devices. Further, a guardrail is not limited to data protection, security, compliance, vulnerability, and infrastructure security. A guardrail can also be applied across cost, observability, performance, and configuration. An example of a cost guardrail is that all development virtual machines should have an AMD brand central processing unit. An example of an observability guardrail can specify autoscaling of a pod given observing unusual alert patterns. Further, mandatory tagging of newly created virtual machines is an example of a configuration guardrail.

A high-level guardrail can then be transformed into a policy and governance definition, such as by extracting such information from the guardrail. In one instance, the policy definition can correspond to a desired state definition. The desired state definition can be communicated through a plugin to one or more management services that map the desired state definition to a resource or resource group associated with on-premises infrastructure. A resource or resource group can correspond to a component or collection of components that may be subject to security or compliance requirements, such as virtual machines (e.g., minimum security configurations, encryption), networks (e.g., access control, firewall), storage (e.g., control, backup, encryption), application services to name a few. Resource state can be monitored for compliance, where resource state corresponds to current configurations, settings, or conditions of a resource or resource group. If the resource state is deemed non-compliant. an enforcement workflow is triggered through one or more services to remediate an issue and bring the system back to the desired state.

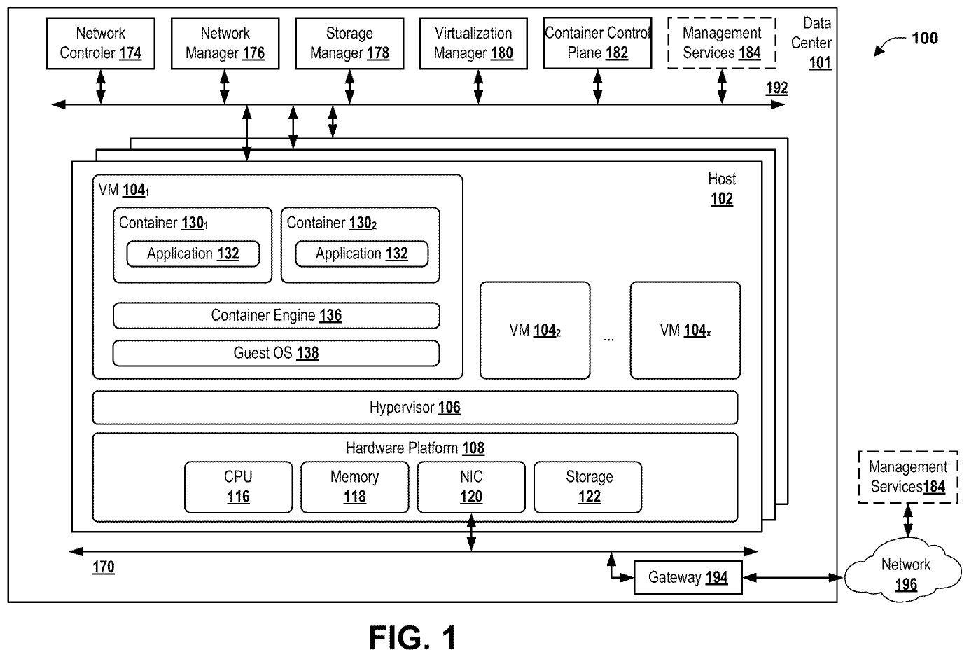

FIG. 1 depicts examples of physical and virtual network components in a networking environment 100 where embodiments of the subject disclosure may be implemented.

Networking environment 100 includes a data center 101. Data center 101 includes one or more hosts 102, a management network 192, a data network 170, a network controller 174, a network manager 176, storage manager 178, virtualization manager 180, container control plane 182, and management services 184. Data network 170 and management network 192 may be implemented as separate physical networks or as separate virtual local area networks (VLANs) on the same physical network. Further, the data center 101 includes gateway 194, enabling communication outside the data center 101 over network 196 (e.g., Internet, Intranet) to access management services 184 externally in an additional or alternative embodiment.

Host(s) 102 may be communicatively connected to data network 170 and management network 192. Data network 170 and management network 192 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or different racks in any arbitrary location in the data center. Host(s) 102 may be configured to provide a virtualization layer, also referred to as a hypervisor 106, that abstracts processor, memory, storage, and networking resources of a hardware platform 108 into multiple VMs 104₁-104ₓ (collectively referred to herein as “VMs 104” and individually referred to herein as “VM 104”)

Host(s) 102 may be constructed on a server-grade or commodity hardware platform 108, such as an x86 architecture platform. Hardware platform 108 of a host 102 may include components of a computing device such as one or more processors (CPUs) 116, system memory 118, one or more network interfaces (e.g., physical network interface cards (PNICs) 120), storage 122, and other components (not shown). A CPU 116 is configured to execute instructions, for example, executable instructions that perform one or more operations described herein and that may be stored in memory 118 and storage 122. The network interface(s) 120 enable host 102 to communicate with other devices through a physical network, such as management network 192 and data network 170.

Each VM 104 implements a virtual hardware platform that supports the installation of a guest OS 138, which is capable of executing one or more applications. Guest OS 138 may be a standard commodity operating system. Examples of a guest OS include Microsoft Windows®, Linux®, or the like.

Each VM 104 may include a container engine 136 installed therein and running as a guest application under the control of guest OS 138. Container engine 136 is a process that enables the deployment and management of virtual instances (referred to interchangeably herein as “containers”) by providing a layer of OS-level virtualization on guest OS 138 within VM 104 or an OS of host 102. Containers 130 are software instances that enable virtualization at the OS level. With containerization, the kernel of guest OS 138, or an OS of host 102 if the containers are directly deployed on the OS of host 102, is configured to provide multiple isolated user-space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132, as a single executable software package that bundles application code with all the related configuration files, libraries, and dependencies required to run. Application 132 may be any software program, such as a word processing program or a gaming server.

Data center 101 includes a container control plane 182. In certain aspects, the container control plane 182 may be a computer program that resides and executes in one or more central servers, which may reside inside or outside the data center 101, or alternatively, may run in one or more VMs 104 on one or more hosts 102. A user can deploy containers 130 through container control plane 182. Container control plane 182 is an orchestration control plane, such as Kubernetes®, to deploy and manage applications or services thereof on nodes, such as hosts 102 or VMs 104, of a node cluster, using containers 130. For example, Kubernetes may deploy containerized applications as containers 130 and a container control plane 182 on a cluster of nodes. The container control plane 182, for each cluster of nodes, manages the computation, storage, and memory resources to run containers 130. Further, the container control plane 182 may support the deployment and management of applications (or services) on the cluster using containers 130. In some cases, the container control plane 182 deploys applications as pods of containers 130 running on hosts 102, either within VMs 104 or directly on an OS of the host 102. Other types of container-based clusters based on container technology, such as Docker® clusters, may also be considered.

Data center 101 includes a network management plane and a network control plane. The management plane and control plane each may be implemented as single entities (e.g., applications running on a physical or virtual compute instance) or as distributed or clustered applications or components. In alternative aspects, a combined manager/controller application, server cluster, or distributed application may implement both management and control functions. In the embodiment shown, network manager 176 at least in part implements the network management plane, and network controller 174 and container control plane 182 in part implements the network control plane.

The network control plane is a component of software defined network (SDN) infrastructure and determines the logical overlay network topology and maintains information about network entities such as logical switches, logical routers, and endpoints. The logical topology information is translated by the control plane into physical network configuration data that is then communicated to network elements of host(s) 102. Network controller 174 generally represents a network control plane that implements software defined networks, e.g., logical overlay networks, within data center 101. Network controller 174 may be one of multiple network controllers executing on various hosts in the data center that together implement the functions of the network control plane in a distributed manner. Network controller 174 may be a computer program that resides and executes in a server in data center 101, external to data center 101 (e.g., such as in a public cloud) or, alternatively, network controller 174 may run as a virtual appliance (e.g., a VM) in one of hosts 102. Network controller 174 collects and distributes information about the network from and to endpoints in the network. Network controller 174 may communicate with hosts 102 over management network 192, such as through control plane protocols. In certain aspects, network controller 174 implements a central control plane (CCP) that interacts and cooperates with local control plane components, such as agents, running on hosts 102 in conjunction with hypervisor 106.

Network manager 176 is a computer program that executes in a server in networking environment 100, or alternatively, network manager 176 may run in a VM 104, such as in one of hosts 102. The network manager 176 communicates with host(s) 102 over management network 192. Network manager 176 may receive network configuration input from a user, such as an administrator, or an automated orchestration platform (not shown) and generate desired state data that specifies logical overlay network configurations. For example, a logical network configuration may define connections between VCIs and logical ports of logical switches. Network manager 176 is configured to receive inputs from an administrator or other entity, e.g., via a web interface or application programming interface (API), and carry out administrative tasks for data center 101, including centralized network management and providing an aggregated system view for a user.

The virtualization manager 180 is a computer program that executes in a server in networking environment 100. The virtualization manager 180 enables management, administration, and control of virtualized environments. The virtualization manager 180 provides a range of functionalities including provisioning and deploying VMs 104, monitoring resource utilization, and managing storage and network configuration, among other things. Administrators can utilize the virtualization manager 180 to allocate and manage computing resources and optimize performance across a virtualized infrastructure.

Management services 184 are tools or services associated with one or more of managing, automating, or orchestrating virtualized environments including the data center 101. For example, the management services 184 can correspond to an operation management service that provides performance monitoring (e.g., vRealize Operations (vRops)) and creation and execution of workflows and processes (e.g., vRealize Orchestrator (vRO)). Management services can correspond to preexisting as well as custom or novel services. Further, the management services can reside inside or outside the data center 101. Inside the data center 101, the management services 184 can utilize the management network 192 to interact with the host 102. The management services 184 outside the data center 101 can access the host 102 through network 196, gateway 194, and data network 170.

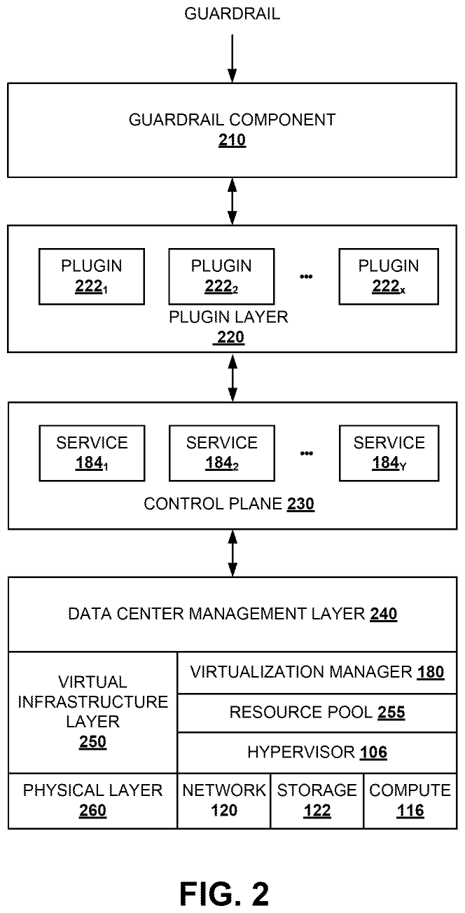

FIG. 2 is a block diagram of a security orchestration system 200 for on-premises infrastructure. On-premises infrastructure can include self-managed and private cloud infrastructures. Self-managed infrastructure refers to a setup where an entity takes responsibility for the design, deployment, configuration, and management of hardware, software, and networking components. A private cloud refers to a cloud computing environment dedicated to a single entity built with resources such as servers, storage, and networking equipment owned and managed by the entity. The security orchestration system 200 includes guardrail component 210, plugin layer 220, and control plane 230.

With respect to FIG. 1, the guardrail component 210 and plugin layer 220 can run within the data center 101 on a physical machine, such as host 102, a virtual machine, such as VMs 104, or in a pod or container, such as containers 130. Additionally, or alternatively, the guardrail component 210 and plugin layer 220 can reside outside the data center 101 and communicate with the data center 101 through the network 196. The control plane 230 corresponds to the set of management services 184 that can reside inside or outside the data center 101, as shown.

The guardrail component 210 is configured to orchestrate security functionality associated with on-premises by delegating control to management services 184. The guardrail component 210 receives a guardrail or policy as input, which can be specified declaratively instead of imperatively. In other words, the policy can specify a desired state of a resource or group of resources instead of the specific steps required to achieve the desired state. For example, a virtual switch address change policy can be set to reject changes to prevent VMs from changing their effective MAC address. In certain embodiments, the policy can be specified as part of a template that provides a guiding framework for best practices and standards that align with industry regulations and internal policies. The guardrail component 210 can analyze the policy and target resource or group of resources to determine how to implement the policy. Part of the analysis can be determining a management service 184 that can implement the policy and associated plugin that can be used to communicate with the management service 184. The output of the guardrail component 210 can be plugin calls that implement an input policy.

Further, the guardrail component 210 can monitor the state of resources to detect a state that does not correspond to the desired state set forth by a policy. The guardrail component 210 can also trigger remediation actions to achieve the desired state. The guardrail component 210 can communicate with a plugin associated with a network service to monitor the state of a resource or group of resources and, if needed, initiate actions to reestablish the desired state.

The plugin layer 220 includes a plurality of plugins 222₁-222ₓ (collectively referred to herein as “plugins 222” and individually referred to herein as “plugin 222”). The plugins 222 in the plugin layer 220 are associated with a particular management service 184 to enable interaction. As input, the plugin layer 220 can receive plugin calls from the guardrail component 210. The output of the plugin layer 220 can be communication of the calls to a target management service 184. In certain embodiments, the management service can expose an application programming interface (API) that a plugin 222 can utilize to communicate with the management service.

The control plane 230 includes a plurality of management services 184₁-184_{Y} (collectively referred to herein as “management services 184” and individually referred to herein as “management service 184”). The control plane 230 receives input from the plugin layer 220 including communication targeting a particular management service 184 and routes the communication to the particular management service 184. As previously noted, management services 184 can correspond to tools associated with managing, automating, or orchestrating virtualized environments including on-premises infrastructure. The services can correspond to preexisting as well as custom or novel services that perform management service that provides performance monitoring (e.g., vRealize Operations (vRops)) and creation and execution of workflows and processes (e.g., vRealize Orchestrator (vRO)), among others.

The management services 184 of the control plane 230 can interact with a data center management layer 240 to implement changes and monitor resources associated with a policy. The data center management layer 240 can monitor and make changes to virtual infrastructure layer 250, which includes hypervisor 106, resource pool 255 (e.g., logical grouping of physical resources such as processors, memory, storage, and network), and virtualization manager 180, per the functionality of the management services 184. The virtual infrastructure layer 250 is implemented on top of and virtualizes the physical layer 260 that includes compute 116, network 120, and storage 122 components.

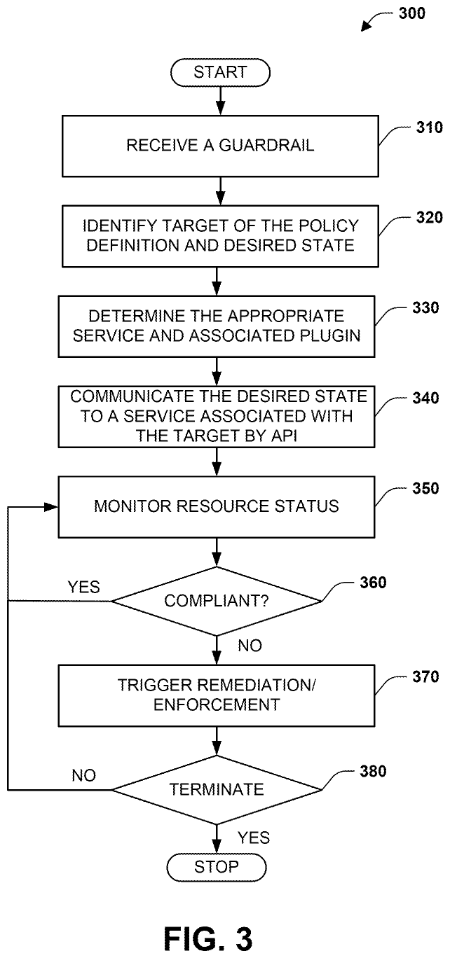

FIG. 3 depicts an example method 300 of security orchestration associated with the security orchestration system 200 of FIG. 2 for on-premises infrastructure. In block 310, a guardrail can be received, for example, by the guardrail component 210. The guardrail does not require a user to implement control and remediation flows but rather supports a simpler approach at a higher level of abstraction. More specifically, the guardrail can include a declarative policy definition that specifies a desired state of one or more resources without an imperative implementation.

As an example, the guardrail received by the guardrail component 210 can be authored by an administrator to correspond to a best practice or standard of ensuring that a virtual switch (vSwitch) with a media access control (MAC) address change policy is set to reject to ensure a virtual machine cannot be misconfigured over time. The guardrail can be authored as a yaml file format, in one embodiment, as follows:

```
META:
  name: Ensure the vSwitch MAC Address Change policy is set to reject
  provider : ESXi
  category: SECURITY
  description: Ensure the MAC Address Change policy within the
  vSwitch is set to reject. Reject MAC changes
{% set rule_name = params.get(‘rule_name’, ‘ESXi Host is violating
CIS’) %}
#CIS ESXi
{{rule_name}}:
  META:
    name: Ensure vSwitch MAC Address Change policy is set to reject
    parameters:
        rule_name:
          name: rule_name
          description: Ensure the MAC Address Change Policy within
          vSwitch is set to reject.
          uiElement: text
  vroplugin.cis.rule.present:
  -virtual_switched: security
  -mac_address_changes: reject
  -tags:
  -Key: name
    Value: {{rule_name}
```

In block 320, the guardrail can be analyzed to identify the target of the policy definition and the desired state, for instance, by the guardrail component 210. The target of the policy definition can be a resource or group of resources. In the preceding example, the policy's target is the vSwitch, and the desired state is the MAC Address Change policy set to reject.

In block 330, an appropriate management service and associated plugin are determined, for instance, by the guardrail component 210. For example, services may be associated with different resources. Given the identification of the target, a matching management service can be determined. Further, given an identified management service, a plugin associated with the identified management service can be determined. For instance, the plugin can correspond to plugin 222, matching management service 184 in FIG. 2. In the ongoing example, the plugin corresponds to a vRealize orchestrator plugin as specified in the guardrail (vroplugin) that interacts with vRealize orchestrator management service, which enables users to run, schedule, and monitor orchestrator workflows.

In block 340, the desired state is communicated to an identified management service, for instance, by the guardrail component 210, through a plugin associated with the management service. For instance, the management service can expose an application programming interface (API) that the plugin can employ to communicate with the management service. In accordance with one embodiment, downstream implementation is delegated to the services. In other words, the management service can accept a desired state as input and execute a series of steps or actions to set the desired state. In accordance with another embodiment, imperative instructions for implementing the desired state may need to be determined, for example, by the guardrail component and communicated downstream.

In block 350, the status of a resource associated with a policy is monitored, for instance, by the guardrail component 210. The status can correspond to the current state associated with the policy. For example, the current state could correspond to the MAC address of a virtual switch. In one instance, another service can be triggered through a corresponding plugin that implements the monitoring and returns status periodically or according to a schedule.

In block 360, a determination is made as to whether or not the resource is compliant, for instance, by the guardrail component 210. A resource can be deemed compliant if the current state matches the desired state specified by a policy. By contrast, the resource can be deemed non-compliant if the current state does not match the desired state specified by the policy. In the ongoing example, the vSwitch is deemed compliant if the vSwitch MAC Address Change policy is set to reject. If the address change policy is not set to reject, but rather accept, for instance, the vSwitch is deemed non-compliant. If the resource status is compliant (“YES”), the method can continue at block 350, where resource status is monitored. If the resource status is non-compliant (“NO”), the method continues to block 370.

In block 370, remediation or enforcement is triggered to place a resource back in a desired state to be compliant, for instance, by the guardrail component 210. In certain embodiments, one or more additional management services can be invoked through corresponding plugins to reestablish the desired state. The concept of drift, or a drift event, can be raised when the configuration of a desired state is changed. With respect to the ongoing example, a drift event can be raised when the vSwitch MAC Address Change policy is set to accept. In response, the remediation or enforcement corresponds to reconfiguring the policy to reject.

In block 380, a decision is made regarding whether or not to continue processing, for instance, by the guardrail component 210. Continued processing can involve monitoring resource status. In some instances, the monitoring can be periodic. Accordingly. the monitoring can be terminated and restarted at a later time. Alternatively, an administrator could trigger termination. If processing is to be terminated (“YES”), then the method terminates. If the process does not terminate (“NO”), then the method continues at block 350.

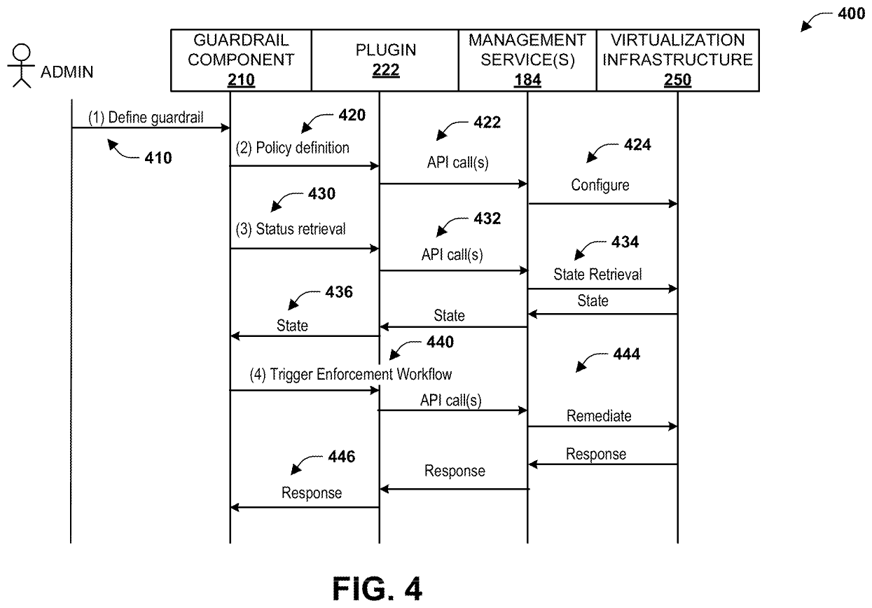

FIG. 4 is a sequence diagram depicting an example execution flow associated with security orchestration, according to an embodiment of the subject disclosure. At 410, an administrator defines a guardrail, or in other words, a declarative policy definition, and provides the policy definition to the guardrail component 210. In one embodiment, the policy definition can be included within a guardrail template that specifies preexisting best practice policies.

The guardrail component 210 receives the guardrail or policy definition from the administrator. Subsequently, the guardrail component 210 can analyze the policy definition to determine an appropriate management service 184 associated with the target of the policy definition. Once a management service 184 is selected, a plugin 222 associated with the management service 184 can be identified.

The plugin 222 receives the policy definition, at 420, from the guardrail component 210. In response, the plugin can communicate the policy definition or portion thereof to the management service 184 through application programming interfaces (APIs) exposed by the management service 184, at 422.

The management service 184 receives the application programming interface calls specifying a policy definition from the plugin 222. Subsequently, the management service configures a resource of the virtualized infrastructure 250, at 424, such that the state corresponds to a desired state.

The guardrail component 210 can periodically or regularly communicate a status retrieval request to the plugin 222 at 430. The request can cause the plugin 222 to issue one or more application programming interface calls to request retrieval of the status from a resource of the virtualization infrastructure 250 at 432. The management service 184 can subsequently request the state for the resource at 434. In response, the state is returned from the virtual infrastructure 250 to the management service 184, from the management service 184 to the plugin 222, and from the plugin 222 to the guardrail component 210.

The guardrail component 210 can compare the current state of a target resource of the virtualization infrastructure 250 to the desired state specified in the policy definition. If the current state does not match the desired state, the guardrail component 210 can trigger an enforcement workflow sent from the guardrail component to a management service 184 through the plugin 222 at 440. The management service 184 executes the enforcement workflow to remediate the issue with resources of the virtualized infrastructure 250 at 444. A response can be sent back, for example, acknowledging the success or failure of the enforcement workflow, from the virtualization infrastructure 250 to the management service 184, from the management service 184 to the plugin 222, and from the plugin 222 to the guardrail component 210, at 446. If the response indicates failure another workflow can be identified and implemented. In accordance with one embodiment, an enforcement management service can be engaged to remedy a state difference. Further, the enforcement management service can reside external to a data center, for example, as a network-accessible service.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities. Usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general- purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer-readable media. The term computer-readable medium refers to any data storage device that can store data that can thereafter be input to a computer system-computer readable media may be based on any existing or subsequently developed technology for embodying computer programs in a manner that enables them to be read by a computer. Examples of a computer-readable medium include a hard drive, network attached storage (NAS), read-only memory, random-access memory (e.g., a flash memory device), a CD (Compact Discs)--CD-ROM, a CD-R, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements or steps do not imply any particular order of operation, unless explicitly stated in the claims.

In accordance with the various embodiments, virtualization systems may be implemented as hosted embodiments, non-hosted embodiments, or embodiments that tend to blur distinctions between the two are all envisioned. Furthermore, various virtualization operations may be wholly or partially implemented in hardware. For example, a hardware implementation may employ a look-up table to modify storage access requests to secure non-disk data.

As described above, certain embodiments involve a hardware abstraction layer on top of a host computer. The hardware abstraction layer allows multiple contexts to share the hardware resource. In one embodiment, these contexts are isolated from each other, each having at least one user application running therein. The hardware abstraction layer thus provides benefits of resource isolation and allocation among the contexts. In the preceding embodiments, virtual machines are used as an example for the contexts, and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers.” OS-less containers implement operating system—level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory, and I/O. The term “virtualized computing instance,” as used herein, is meant to encompass both VMs and OS-less containers.

Many variations, modifications, additions, and improvements are possible, regardless of the degree of virtualization. The virtualization software can therefore include components of a host, console, or guest operating system that performs virtualization functions. Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of orchestrating security policy, comprising:
receiving a policy definition associated with on-premises infrastructure that defines a desired state;
identifying a target of the on-premises infrastructure from the policy definition;
determining a management service associated with the target;
identifying a plugin for the management service; and
communicating the policy definition to the management service through the plugin, wherein the management service sets a state of the target to the desired state.

2. The method of claim 1, further comprising:
requesting a current state of the target from the management service through the plugin;
receiving the current state;
determining the current state is different from the desired state by comparing the current state and the desired state; and
initiating a remediation workflow to set the target to the desired state.

3. The method of claim 1, wherein receiving the policy definition comprises receiving a policy definition template that specifies a predefined policy.

4. The method of claim 1, wherein communicating the policy definition comprises invoking the plugin, wherein the plugin communicates with the management service through an application programming interface exposed by the management service.

5. The method of claim 1, wherein identifying the target comprises identifying a hypervisor.

6. The method of claim 1, wherein identifying the target comprises identifying a virtualization manager.

7. The method of claim 1, wherein identifying the target comprises identifying a virtual resource.

8. A system, comprising:
one or processors coupled to one or more memories that store instructions, that when executed by the one or more processors, cause the system to:
receive a policy definition associated with on-premises infrastructure that defines a desired state;
identify a target of the on-premises infrastructure from the policy definition;
determine a management service associated with the target;
identify a plugin for the management service; and
communicate the policy definition to the management service through the plugin, wherein the management service sets a state of the target to the desired state.

9. The system of claim 8, wherein the instructions further cause the system to:
request a current state of the target from the management service through the plugin;
receive the current state;
determine the current state is different from the desired state by comparing the current state and the desired state; and
initiate a remediation workflow to set the target to the desired state.

10. The system of claim 8, wherein policy definition is included within a template that specifies a predefined policy.

11. The system of claim 8, wherein the plugin communicates with the management service through an application programming interface exposed by the management service.

12. The system of claim 8, wherein the management service is an external service accessible through the plugin.

13. The system of claim 8, wherein the on-premises infrastructure comprises a private cloud.

14. The system of claim 8, wherein the target is one of a hypervisor, a virtualization manager, or a virtual resource.

15. One or more non-transitory computer-readable media comprising instructions that, when executed by one or more processors of a computing system, cause the computing system to perform a method for security policy orchestration, the method comprising:
receiving a policy definition associated with on-premises infrastructure that defines a desired state;
identifying a target of the on-premises infrastructure from the policy definition;
determining a management service associated with the target;
identifying a plugin for the management service; and
communicating the policy definition to the management service through the plugin, wherein the management service sets a state of the target to the desired state.

16. The one or more non-transitory computer-readable media of claim 15, the method further comprising:
requesting a current state of the target from the management service through the plugin;
receiving the current state;
determining the current state is different from the desired state by comparing the current state and the desired state; and
initiating a remediation workflow to set the target to the desired state.

17. The one or more non-transitory computer-readable media of claim 15, wherein receiving the policy definition comprises receiving a policy definition template that specifies a predefined policy.

18. The one or more non-transitory computer-readable media of claim 15, wherein communicating the policy definition comprises invoking the plugin, wherein the plugin communicates with the management service through an application programming interface exposed by the management service.

19. The one or more non-transitory computer-readable media of claim 15, wherein identifying the target comprises identifying a hypervisor.

20. The one or more non-transitory computer-readable media of claim 15, wherein identifying the target comprises identifying one of a virtualization manager or virtual resource.
